(19) United States
(12) Patent Application Publication
(10) Pub. No.: US 2023/0177428 A1
(43) Pub. Date: Jun. 8, 2023

(54) SYSTEM AND METHOD FOR DETECTING PRICE ERRORS AND DISCREPANCIES

(71) Applicant: Genpact Luxembourg S.à r.l. II, Luxembourg (LU)

(72) Inventor: David I. Hauser, Merrick, NY (US)

(21) Appl. No.: 17/544,683

(22) Filed: Dec. 7, 2021

(51) Int. Cl. G06Q 10/06; G06F 16/2457; G06F 16/22

(52) U.S. Cl. CPC G06Q 10/06315; G06F 16/24578; G06F 16/2282

(57) ABSTRACT

A method for detecting price errors and/or discrepancies includes receiving an item file containing at least retail store identifiers, product identifiers corresponding to products sold in stores associated with the store identifiers, and product prices corresponding to the product identifiers. The method further includes creating a dataset having a first grouping with the store identifiers, a second grouping with the product identifiers, and a third grouping with the product prices; selecting a group of the stores based on one or more criteria; and applying regression analysis on the dataset to predict a price for each product across the group of the stores. Additionally, the method includes ranking residuals from the regression analysis to identify, within the group of the stores, products whose prices do not match their predicted prices.

### TECHNICAL FIELD

This disclosure relates to a method and system for detecting price errors and discrepancies across multiple retailer locations to prevent revenue, margin, or profit leakage.

### BACKGROUND

Retailers use item files to keep track of procurement and retail prices for products bought from their suppliers and carried in their stores. Accordingly, suppliers use item files to keep track of the agreed upon procurement prices for products sold to retailers. Therefore, an item file can be a master list that includes product identifiers for products being bought or sold, related pricing information, product quantities, etc. For example, an item file may include the product name, the product description, the product number in a form of a code, the retail price of the product, the procurement price of the product, the quantities shipped for each product, etc. Depending on the user (e.g., retailer or supplier), additional information may be included, such as vendor/supplier/manufacturer name, payment terms, date of last price change, and the like.

Retail stores have specific characteristics or features (e.g., store size, layout, days/hours of operation, type, etc.) that can impact the procurement pricing. For example, some stores may be far from the manufacturer and thus the procurement prices for them could be higher due to increased transportation costs. Other stores, being closer to the manufacturer, may have lower transportation costs and lower procurement prices respectively. Therefore, store features or characteristics can influence the procurement prices these stores can achieve, which (in addition to any net influences from supply and demand) can dictate their retail pricing policy.

Based on the above, and looking at the same product across many stores, it would be unreasonable to assume that every store has an identical agreed upon procurement price with a supplier given the differences between stores (supply/demand, distances to supplier, store type, etc.). For this reason, price variability between stores, even for the same retailer, is not uncommon. Due to the price variability across stores, often times price discrepancies and errors are undetected, and when or if detected, the magnitude of the discrepancy is often misread with significant financial implications for the parties involved.

### SUMMARY

To address the aforementioned shortcomings, a method and system for detecting price errors and discrepancies across an extended number of stores and products is disclosed. In some embodiments, a baseline price is calculated for each product in a group of stores and the actual price of each product is then compared to its baseline price to identify pricing errors in the group of stores. In some embodiments, a predictive model (e.g., a regression model) is used to make price predictions for each product across all stores or across a subset of stores. Subsequently the residuals (e.g., the regression residuals) are used to identify product pricing issues across one or more products and stores. In some embodiments, the model uses natural language processing (NLP) and artificial intelligence (AI)-based engineering.

In some embodiments, the method and system disclosed herein can be used by retailers, suppliers, or third parties who have access to item files from retailers and suppliers to detect procurement and retail pricing errors and discrepancies for an extended number of products and services, and for an extended number of stores, vendors, and sources of commerce.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the Figures is below.

FIGS. 1A and 1B show a flow chart of a method for detecting price errors and discrepancies for one or more products across retail stores, according to some embodiments.

FIG. 2 is a system for detecting price errors and discrepancies for one or more products across retail stores using the methods described herein, according to some embodiments.

FIG. 3 is a server as part of a system used in a method for detecting price errors and discrepancies for one or more products across retail stores, according to some embodiments.

FIGS. 4A-C are datasets used in a method for detecting price errors and discrepancies for one or more products across retail stores, according to some embodiments.

FIG. 5 is a scatter plot that compares the actual price of a product to the product's baseline price across a group of stores, according to some embodiments.

FIGS. 6 and 7 are scatter plots of actual versus predicted retail prices for multiple product codes across a selected group of stores, according to some embodiments.

FIG. 8 is a scatter plot that compares prices between a first supplier-product combination and a second supplier-product combination, according to some embodiments.

FIG. 9 is a partial screenshot from a table containing information extracted from an item file, according to some embodiments.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Item files are used by suppliers and retailers alike to keep track of vital information about products they sell, buy, and carry, and the services they offer, procure, and support. By way of example and not limitation, and depending on who owns the item file, such vital information can include product identifiers (e.g., universal product codes (UPC), stock-keeping unit (SKU) codes, product description, etc.), product retail prices, product procurement prices, unit sizes available for each product, product description, store name and location, etc. In some instances, additional information may also be included, such as product features or other info, vendor information, and the like. Item files may be created via a third party software or they can be developed by the client. Regardless of the file's source, item files are commonly saved in centralized locations, such as on cloud servers, where they can be easily and safely accessed.

According to some embodiments, data from items files can be used as input parameters for the method and system disclosed herein. For example, data from one or more item files can be extracted, re-structured, reformatted, converted, and supplemented to be used as input parameters for the analysis performed by the method and system disclosed herein. According to some embodiments, one or more item files from one or more clients can be imported for the analysis described herein.

According to some embodiments, one or more natural language processing (NLP) and artificial intelligence (AI) models extract, parse, re-arrange, and reformat the data from the one or more item files to create datasets for one or more predictive models. Once the data are analyzed, they are dissected, compiled, and presented in an appropriate format (e.g., a combination of plots and tables) so that product price discrepancies between, for example, store locations, vendors, or suppliers are easily identified and investigated.

### Model Description

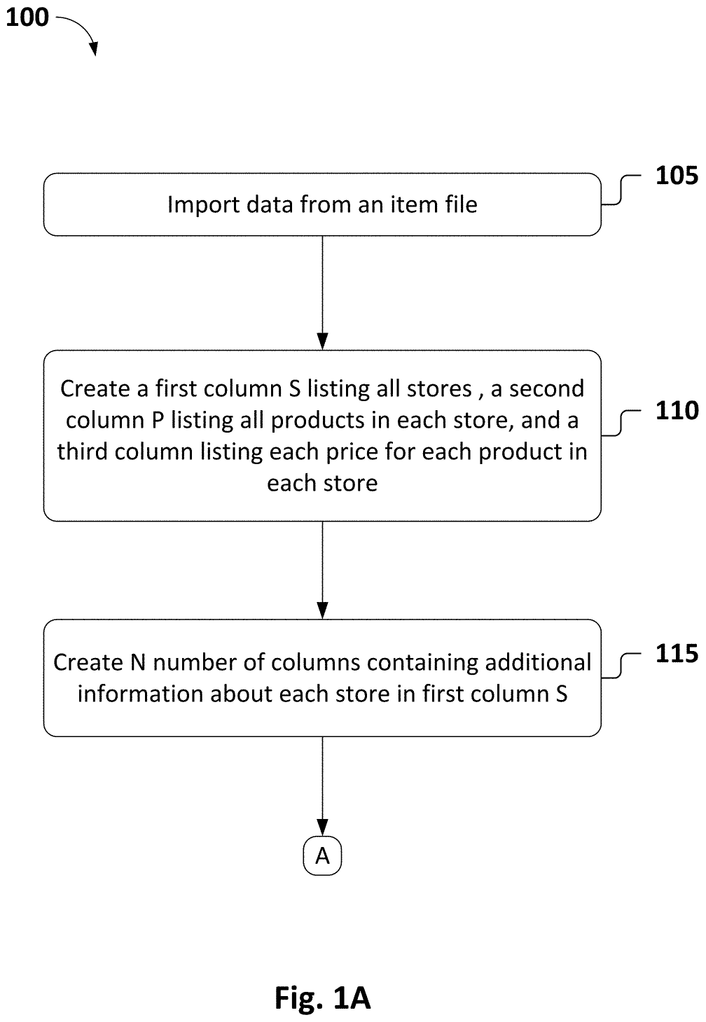

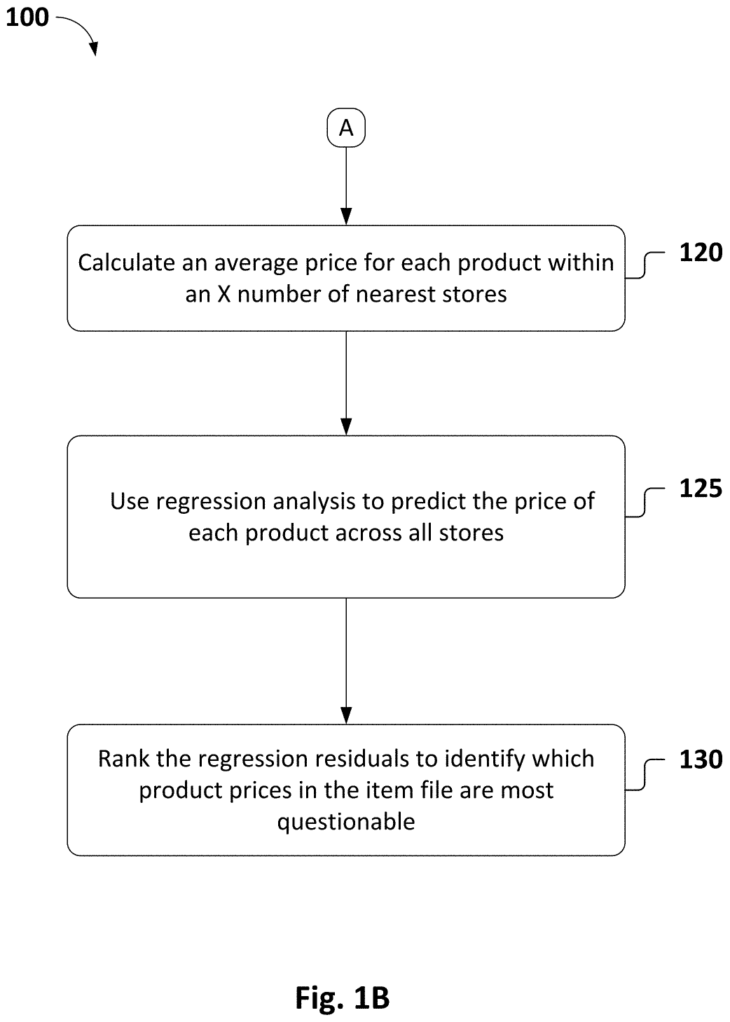

According to some embodiments, FIGS. 1A and 1B show a flow chart of a method 100 for detecting price errors and/or discrepancies, including but not limited to price outliers, for an extended number of products or services across various channels and mechanisms for selling or otherwise making available products and services. Such channels and mechanisms can include, without limitation, retail stores, ecommerce channels, and other platforms on which products and services can be sold. For simplicity, the present description refers to “store” and “stores”; however, it should be understood that these terms can refer to and/or include any channels and mechanisms for providing products and services. Other operations may be performed between the various operations of method 100 and may be omitted merely for clarity. This disclosure is not limited to this operational description. For example, additional operations may be performed. Moreover, not all operations may be needed to perform the disclosure provided herein. Additionally, some of the operations may be performed simultaneously, or in a different order than that shown in FIGS. 1A and 1B. In some embodiments, one or more other operations may be performed in addition to or in place of the presently described operations.

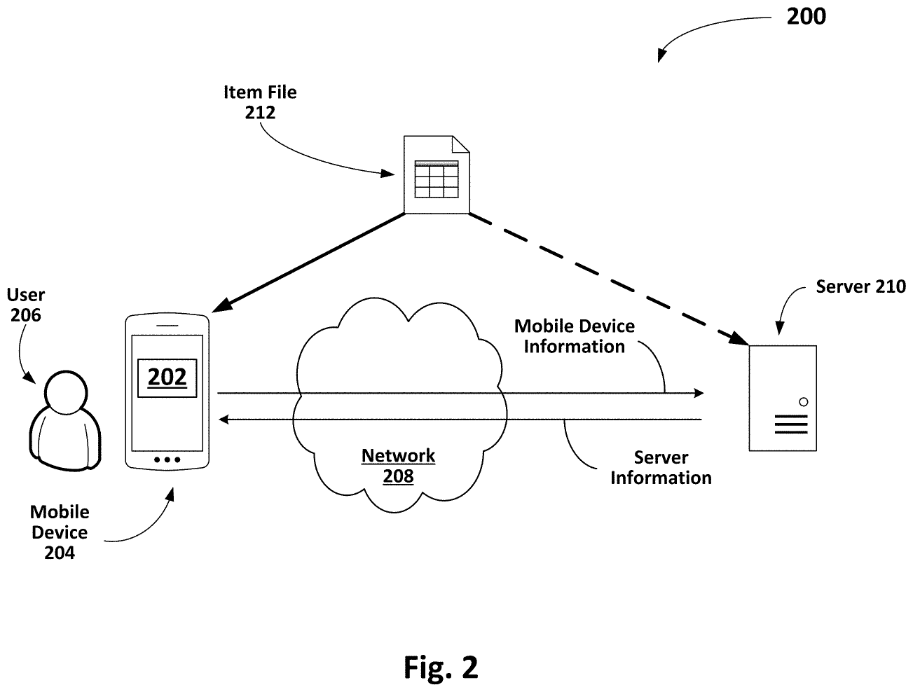

According to some embodiments, the operations of method 100 are executed using an exemplary system 200 shown in FIG. 2. By way of example and not limitation, method 100 can be executed, at least in part, by a software application 202 running on a mobile device 204 and operated by a user 206. By way of example and not limitation, mobile device 204 can be a smart phone device, a tablet, a tablet personal computer (PC), a laptop PC, etc. In some embodiments, mobile device 204 can be any suitable electronic device connected to a network 208 via a wired or wireless connection and capable of running software applications, like software application 202. In some embodiments, mobile device 204 is a desktop PC running software application 202. In some embodiments, software application 202 is installed on mobile device 204 or is a web-based application running on mobile device 204 (e.g., a cloud-based software used by businesses, such as a Software-as-a-Service (SAAS)).

By way of example and not limitation, user 206 can be a person interacting with software application 202—e.g., a person uploading files to and/or reviewing data presented by software application 202.

By way of example and not limitation, network 208 can be an intranet network, an extranet network, a local network, a public network, or combinations thereof used by software application 202 to exchange information with one or more remote or local servers, such as server 210. According to some embodiments, software application 202 is configured to exchange information, via network 208, with additional servers that belong to system 200 or other systems similar to system 200 not shown in FIG. 2. Additionally, software application 202 may use network 208 to access the world wide web and any number of servers and/or services that allow software application 202 to operate as intended.

In some embodiments, server 210 is configured to store, process, and analyze information and input received from user 206, via software application 202, and subsequently transmit in real time processed data back to software application 202. Server 210 can include a number of modules and components discussed below in reference to the operations of method 100. According to some embodiments, server 210 performs at least some of the operations discussed in method 100. In some embodiments, server 210 is a cloud-based server. In some embodiments, server 210 includes a collection of servers configured to communicate with one another and with software application 202.

In referring to FIG. 1A, method 100 begins with operation 105 and the process of importing data from an item file. In some embodiments, operation 105 may include importing data from multiple item files. The item file may belong to a retailer or supplier, and may include at least product and pricing information for multiple stores. The type of data and information used to describe method 100 are merely an example and are not limiting. Therefore, different or additional data included in an item file are within the spirit and scope of this disclosure.

As discussed above, the item file should include, at a minimum, a list of product identifiers for each product P with respective product prices (retail, procurement, or both) and store identifiers for each store S. Examples of product identifiers include, but are not limited to, UPC numbers, SKU numbers, product descriptions, product names, product packaging details, product supplier/manufacturer information, product quantities, or any combinations thereof. Examples of store identifiers include, but are not limited to, store numbers, store full address, store zip code, retailer name, store size (e.g., the store's square footage). Additional information about the stores may also be included—e.g., demographics of the stores' geography, sales per department, proximity to suppliers, etc. In some embodiments, additional store information, even though not required, improve the accuracy of the predictive model and provide additional insights to the user.

In some embodiments, data import is initiated via uploading item file 212 from a centralized location (e.g., from a cloud server) to server 210 via mobile device 204 and network 208 as shown in FIG. 2. However this is not limiting, and server 210 may directly download item file 212 from a centralized location without the intervention of mobile device 204 as indicated by the dashed arrow in FIG. 2. In any event, when item file 212 is uploaded to server 210, it is saved in a database within server 210.

In some embodiments, once item file 212 is saved in server 210, the data extraction process begins. In some embodiments, data extraction includes, but is not be limited to, identifying relevant information for the analysis, extracting this information, re-arranging it, and properly re-formatting it to create one or more extended datasets which are used as input to a predictive analysis model.

In some embodiments, this can be achieved with the use of NLP and AI-based engineering. For example, NLP models and AI-based models may be configured to scan the item file for information, parse text fields, identify important terms and numbers, collect all the relevant information, and group the collected data appropriately. For example, the NLP and AI-based models must be capable of recognizing that a product description including the terms “milk” and its abbreviation “mlk” refer to the same product type and that the corresponding data need to be categorized in the same analysis bucket, or that “ounces” and “oz.” refer to the same unit. Further the NLP and AI-based models need to identify which data are store information, which data are product information, which numbers corresponding to zip codes and which numbers correspond to sales, to UPC and SKU codes, to square footage, so that they are properly categorized.

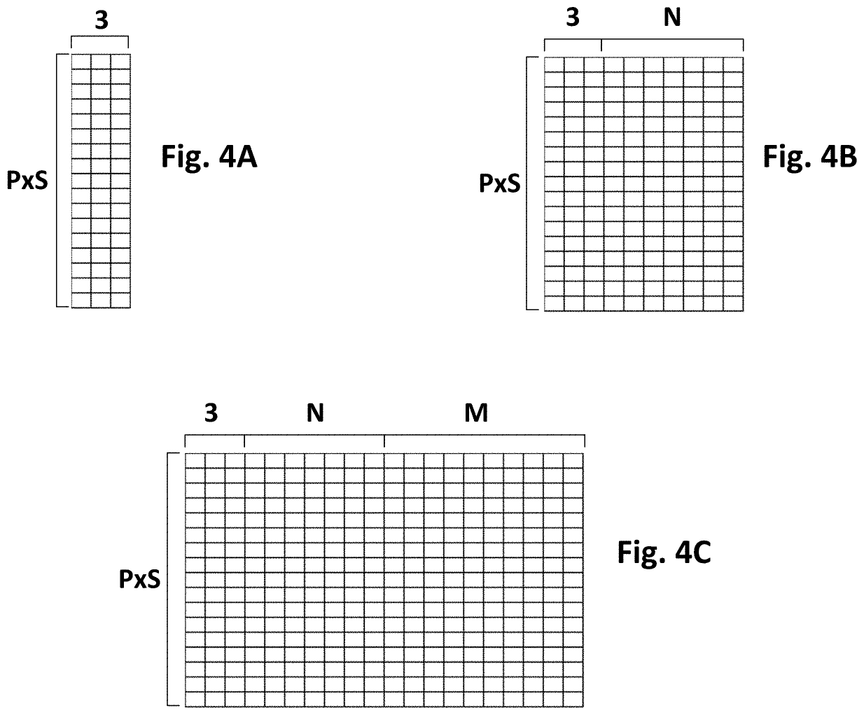

Once key information and variables have been identified, the process of re-organizing and grouping the data commences. In some embodiments, operation 110 of method 100 describes such an operation. By way of example and not limitation, an AI-based model may perform the operations described in operation 110 of method 100. According to operation 110, an AI-based model creates a first column S that lists all the store numbers identified in item file 212, creates a second column P that lists all the products in each store of the first column S, and creates a third column that lists each price for each product in second column P. Therefore, an initial dataset is formed having 3 initial columns (e.g., column 1 with the store number, column 2 with product identifiers, and column 3 with the price per product). At this stage the dataset has P times S (P×S) number of rows as shown in FIG. 4A.

If additional store data are available and included in item file 212 (e.g., zip code information for each store, demographic information, or sales figures per department per store as discussed above), they can be included in the dataset as a separate number of columns N according to operation 115 of method 100. Consequently, after operation 115, the dataset can have between 3 and 3+N number of columns of data as shown in FIG. 4B, where N is equal to or greater than zero (e.g., N≥0).

According to some embodiments, the store number in column 1 may not be a modellable variable. For example, it can be only used to merge demographics or other store-related variables, such as sales per department, other sales figures, square footage, etc. In some embodiments, other non-continuous variables, such as the store zip codes, store type, etc. in columns N, are treated as categorical variables.

In referring to FIG. 1B, method 100 continues with operation 120 and the process of calculating an average price for every product (e.g., APᵢ with i=1 through n, where n is the number of products in each store) within an X number of nearest stores to create a new continuous variable included as a new column into the dataset. In some embodiments, a median price for every product (e.g., MPᵢ with i=1 through n, where n is the number of products in each store) within an X number of nearest stores is calculated in addition to or in place of the average price.

According to some embodiments, the nearest X stores can be selected based on geographical location criteria such as the zip code. However, this is not limiting, and according to some embodiments, the selection of X number of stores may be based on other or additional criteria (e.g., not related to store-to-store proximity) such as square footage, sales volume, store proximity to a supplier, store proximity to a mall or other businesses, stores with similar restock/reorder frequencies, similar store types, stores with similar distances to highways, etc. In some embodiments, variations include, but are not limited to, calculating the average or median product prices across X number of nearest stores of the same type versus the nearest X stores of the same size, across all stores in the same zip code, across stores in the same county, across stores in surrounding or neighboring counties, across all stores in the same state, across all stores in surrounding or neighboring states, and so on. In other words, additional continuous variables featuring average and/or median prices of products can be calculated for any desirable combination of X number of stores based on preference and how the results will be dissected and analyzed later. Based on the above, X can be any integer greater than one.

For example purposes, X in method 100 will be described in the context of number of nearest stores. However, as discussed above, this is not limiting and X can be selected based on any desirable criteria.

According to some embodiments, the average price for each product within an X number of nearest stores is added as an additional column M to the dataset. However, if desired, operation 120 may result in multiple columns as additional continuous variables are calculated. Therefore, M can be equal to or greater than 1 (e.g., M≥1). According to some embodiments, at the end of operation 120, there are 3+N+M number of columns in the dataset as shown in FIG. 4C, where N is equal to or greater than 0 (e.g., N≥0) and M is equal to or greater than 1 (e.g., M≥1).

As discussed above, and in referring to FIG. 4C, the final dataset includes 3 original columns (e.g., store number or identifier, product number or identifier, and price for each product-store combination), N number of columns with available store descriptors included in the item file (e.g., store information like size, sales, type, zip code, etc.), and M number of columns with additional calculated continuous variables (e.g., mean/median product price for the nearest X stores, mean/median product price for the nearest X similar type stores, mean/median product price for all the stores of the same type in the county/state, etc.).

According to some embodiments, operation 120 offers a price baseline for each product (e.g., a baseline for the mean price or the median price) within a subset of stores (e.g., within the X number of grouped stores) to which the actual product prices can be compared to and outlier stores can be identified and flagged. Outlier stores refer to stores that price one or more products outside the user predefined statistical limits, such as 1 standard deviation (1σ), 2 standard deviations (2σ), 3 standard deviations (3σ), and the like.

For example, the actual price for product 1 in store 1 (P₁S₁) may be 20 dollars. However, for the nearest X stores, the average value for product 1 (e.g., price baseline AP₁) may be 35 dollars. This means that there is a 15-dollar price difference between the actual price P₁S₁ and the baseline price AP₁. This price difference may or may be significant and the only way to determine such a scenario is by comparing the price difference to another price different from another store. For example, the price for product 1 in store 2 (P₁S₂) may be 34.5 dollars, which results in a difference between P₁S₂ and AP₁ of only 50 cents. Based on the above, store 1 could be a potential outlier store for product 1, and most likely it needs to be further investigated to understand the reason behind the price difference. Perhaps, the reason could be that there is a clerical error in the item file or someone in the store entered the wrong pricing information for the product.

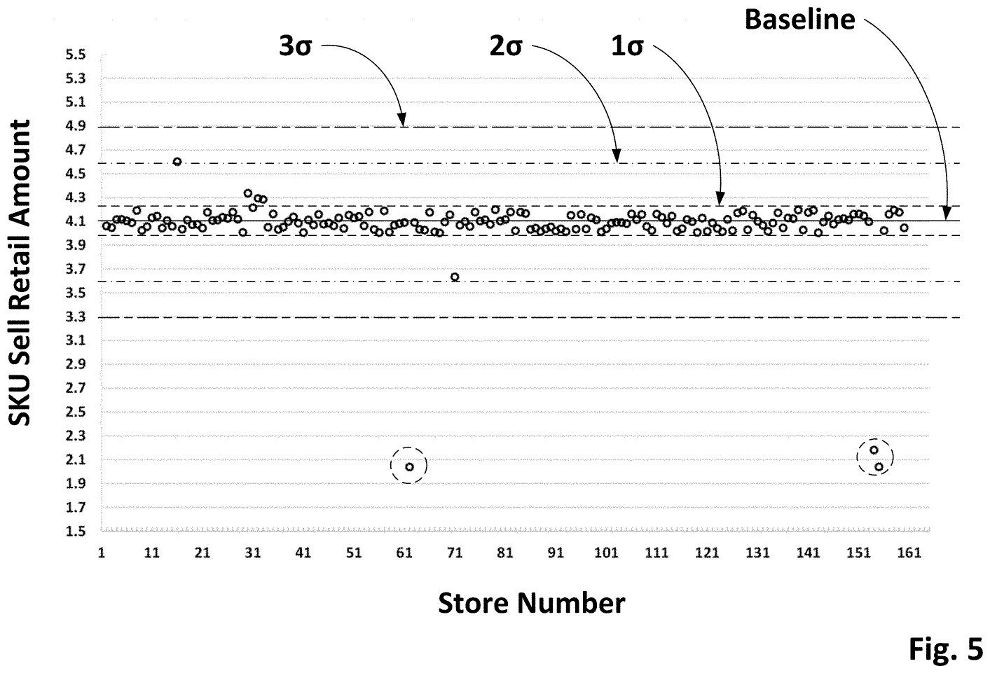

Following this methodology and by plotting the price of a product (Pᵢ) for X number of stores against its price baseline (e.g., APᵢ), multiple outlier stores from the group can be identified and flagged. An example is provided in FIG. 5 where the actual retail price for a particular product SKU is plotted across a group of stores (e.g., X number of stores) against its price baseline—e.g., against its average price value within the X number of stores. In the example of FIG. 5, three outlier stores are identified which sell this particular product substantially lower (e.g., outside the 3σ limits) than the rest of the fleet as indicated by the dashed circles. In some embodiments, any desired limits may be implemented for the identification of outlier stores. By way of example and not limitation, a threshold may be set at 3σ of the entire price distribution. Thus, if the price for a product in one or more stores falls outside the 3σ limits, the one or more stores are flagged as outliers. Similarly, if the limits are set to 1σ or 2σ, additional stores will be flagged. However, tighter limits (e.g., between 1σ or 2σ) may falsely highlight stores whose pricing is justifiable based supply and demand or other factors. Therefore, the user may decide which limits are most appropriate for each group of stores.

Similar plots can be generated for every product SKU within the same or different selection of stores as discussed above. Additionally, the baseline and limits may be selected accordingly. Therefore, all the possible combinations and permutations are within the spirit and the scope of this disclosure.

In some embodiments, a predictive analysis (e.g., regression, decision trees, or cross tabulations) is used to predict the price of each product across all stores according to operation 125 of method 100 shown in FIG. 1B. For example purposes, the predictive analysis used in operation 125 will be described in the context of regression analysis. Based on the disclosure herein, other predictive analyses can be used, including, but not limited to, decision trees and cross tabulations. These other predictive analyses are within the spirit and the scope of this disclosure. In some embodiments, the actual price of a product is modeled against the remaining independent variables of the dataset. According to some embodiments, ranking the regression residuals (e.g., operation 135 of method 100) provides an indication of which product prices in the item file are most questionable and have a higher probability of containing an error.

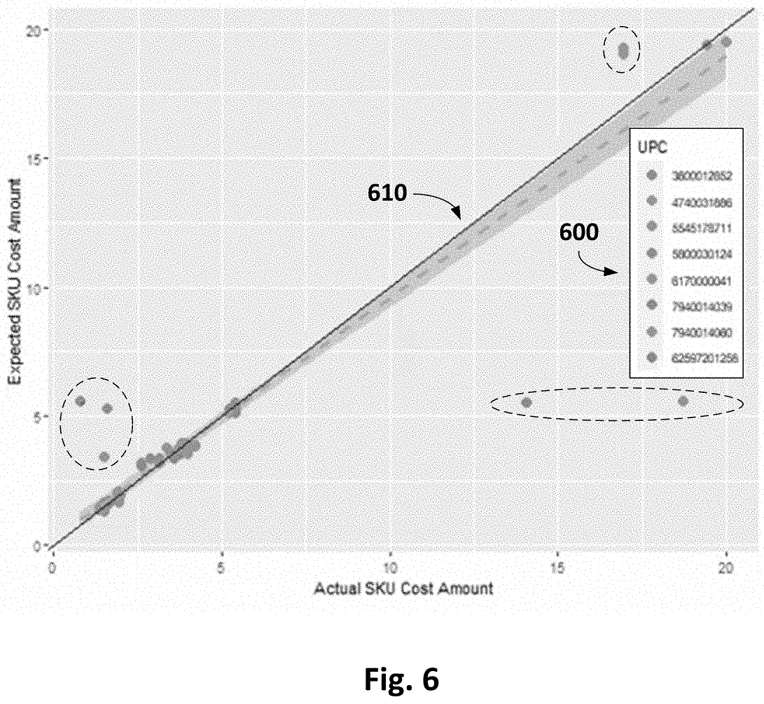

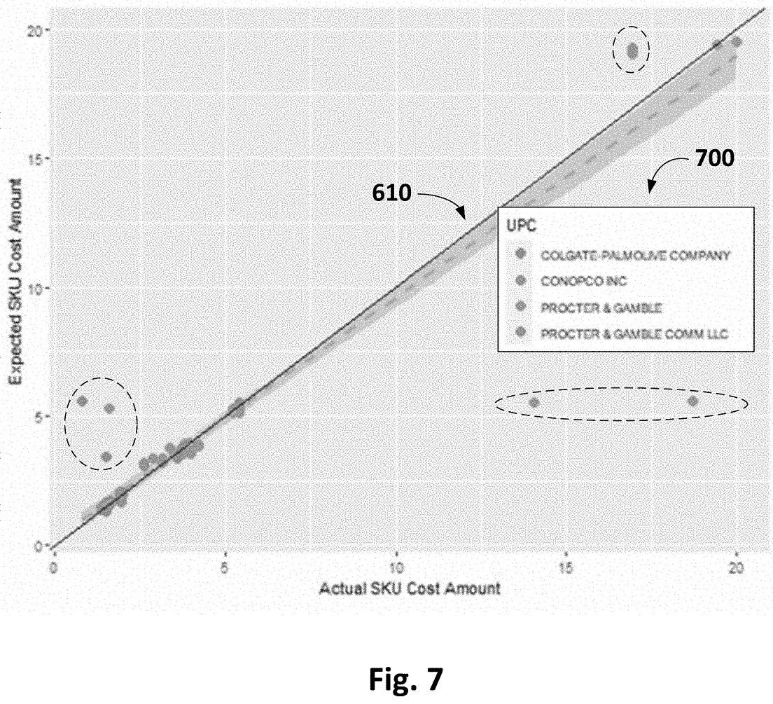

Once the regression analysis is performed, the data may be plotted and filtered any number of ways to provide insights and recommendations. By way of example and not limitation, FIGS. 6 and 7 are partial screenshots from software application 202 as viewed by user 206 that show scatter plots of actual versus expected (e.g., predicted) retail prices for multiple SKU product codes across a selected group of stores (e.g., X number of stores). Each plot shows the same set of data filtered in a different way as indicated by their respective legends 600 and 700 (e.g., by UPC description, by UPC code, or in any other preferred way). In these scatter plots, each data point corresponds to a price of a product within a store in the selected group of stores. Data points on or substantially proximal to intercept 610 correspond to stores that price their products so that there is a considerable match between their actual and expected prices. Data points above or below the intercept, as indicated with the dashed line circles, correspond to stores that, for whatever reason, have either underpriced or overpriced these products compared to their respective expected prices. The products with non-expected price differences, represent products with a greater probability of being mispriced. Calculating the difference between the actual and the predicted price of each mispriced product as a ratio to the actual product price (e.g., percent of actual), and sorting the stores by this ratio, allows pricing managers to make targeted and prioritized decisions so that prices of mispriced products are adjusted accordingly.

Based on these scatter plots, user 202 may investigate why some of the stores have their products overpriced or underpriced compared to other stores in the group. Perhaps, there is only a family of products that is affected (e.g., overpriced or underpriced) or only products from a specific supplier. Whatever the case may be, scatter plots like the ones shown in FIGS. 6 and 7 can identify potential pricing issues across a large number of stores and products.

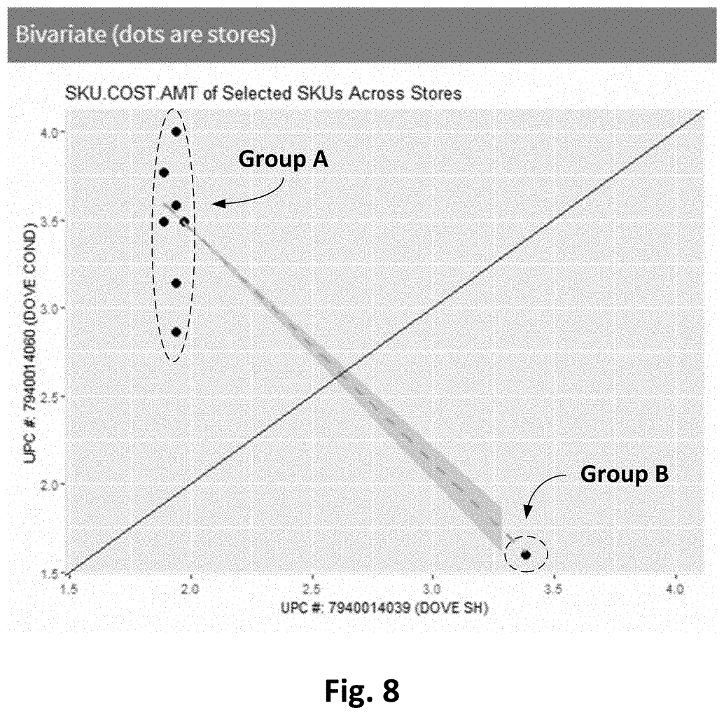

In some embodiments, scatter plots can also be used to look at prices of two or more related or unrelated products and identify stores that price these products substantially different from other stores in the group. By way of example and not limitation, FIG. 8 is a partial screenshot from software application 202 as viewed by user 206 that shows a scatter plot in which prices for a first supplier-product combination are shown on the Y axis and the prices for a second supplier-product combination are shown on the X axis. In some embodiments, the suppliers are the same but the products are different (e.g., shampoo versus conditioner from the same supplier/manufacturer), the suppliers are different but the products are similar (e.g., milk from different suppliers), the suppliers and the products are different. According to some embodiments, any possible or plausible combinations/permutations between suppliers and products is within the spirit and the scope of this disclosure.

According to some embodiments, the data points on the scatter plot correspond to stores. Two or more data points may substantially overlap on the scatter plot and may appear to a viewer as a single data point. According to the scatter plot, there is a data point, or a group of overlapping data points, annotated as Group B that is separated from the rest of the data point population annotated as Group A. This is an indication that the store or the stores that produced the data point(s) in Group B have reversed the prices of the two products. This for example, could be due to a pricing error when the two products were placed in the store(s) that produced the data point(s) of Group B. If unnoticed, these errors can cause substantial cost leakage for the retailer.

In some embodiments, additional types of plots and/or graphs may be provided to further dissect, analyze, and compile the data. Therefore, the examples provided in reference to FIGS. 5-8 are not limiting, and additional types of plots and graphs may be generated and presented to a user. In some embodiments, analyzed data may be presented in tabular format, a combination of plots and tables, or in any convenient format that is appropriate for the presentation and analysis of the data.

### System Description

In some embodiments, the operations of method 100 occur automatically in the backend (e.g., within server 210 shown in FIG. 2) without user intervention. For example, and in referring to FIG. 2, once user 206 uploads item file 212 via software application 202 to server 210, item file 212 can be, for example, locally saved in server 210 within a database. Thereafter the data from item file 212 are extracted, re-formatted, coded, and re-arranged so that an initial dataset is compiled as described in reference to operations 110 and 115 of method 100.

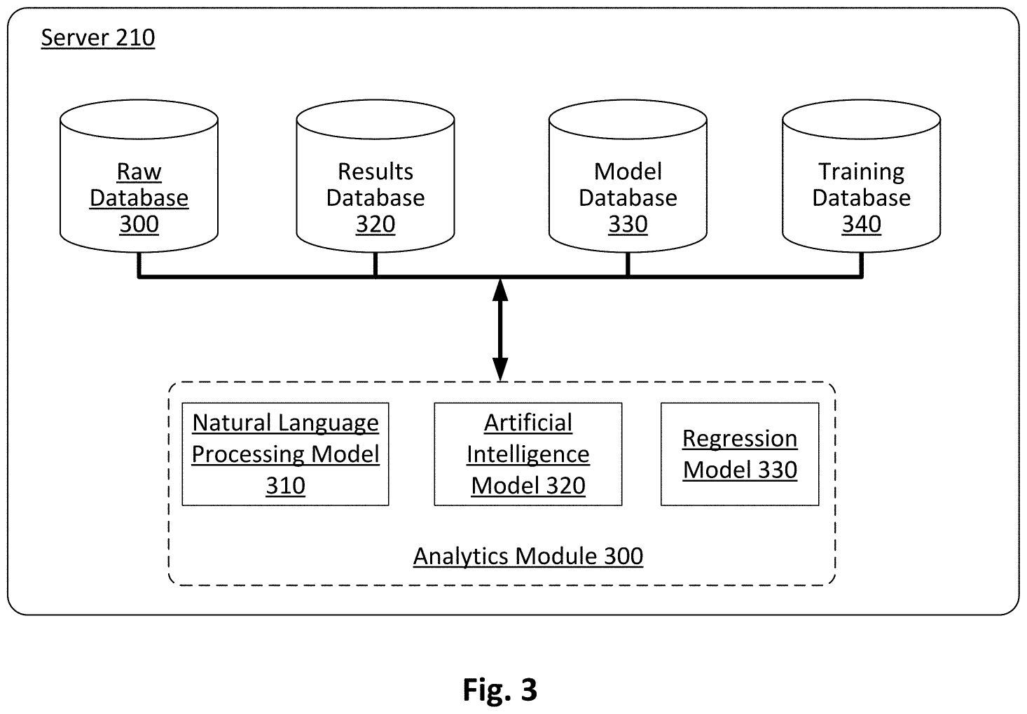

According to some embodiments, FIG. 3 shows selective components of server 210 used to perform selective operations of method 100. Server 210 may include additional components not shown in FIG. 3. For example, these additional components, which are omitted merely for simplicity, may include, but are not limited to, computer processing units (CPUs), graphical processing units (GPUs), memory banks, graphic adaptors, external ports and connections, peripherals, power supplies, and the like required for the function and proper operation of server 210. The aforementioned additional components and other components required for the operation of server 210 are within the spirit and the scope of this disclosure.

As discussed above, text in the original data needs to be parsed and coded so that it can be used as input in the one or more regression models. In some embodiments, one or more NLP and AI models are configured to recognize and analyze text to extract information that is relevant to the regression analysis. By way of example and not limitation, text in the original data can be recoded, classified, and analyzed following commonly used recoding approaches applied in NLP-based and AI-based models.

In some embodiments, the NLP and AI models are able to recognize and correct spelling errors in the data. Additionally, the NLP and AI models may be configured to identify key terms and isolate them or assign to them a particular weight. Alternatively, the NLP and AI models may be configured to rate each term and assign to it a weight base on a predefined importance list. Further, the NLP and AI models may be configured to recognize and isolate numerical information embedded in the text.

By way of example and not limitation, the NLP and AI models used to analyze text and numerical data form the item file can be located in an analytics module within server 210, like NLP model 310 and AI model 320 in analytics module 300 shown in FIG. 3. In addition, analytics module 300 of server 210 may include a regression model, like regression model 330, responsible for processing and analyzing the output from NLP model 310 and AI model 320. In some embodiments, analytics module 300 in server 210 may include a subset of the models used in method 100; for example, the rest of the models may be present on other servers communicatively coupled to server 210 not shown in FIG. 3. In some embodiments, analytics module 300 of server 210 includes all the models used in method 100.

According to some embodiments, server 210 includes one or more databases that are communicatively coupled to analytics model 300 and operate as permanent or temporary data storage locations for the operations in method 100. These databases can be hard disk drives (HDDs), solid state drives (SSDs), memory banks, or any other suitable storage medium to which the models in server 210 (e.g., NLP model 310, AI model 320, and regression model 330) have read and write access. In some embodiments, the databases of server 210 are partitions or directories in a HDD, SDD, memory bank, or in a suitable storage medium.

In some embodiments, item file 212, when downloaded to server 210, is saved in raw database 300, and the output data from NLP model 310, AI model 320, and regression model 330 are saved in results database 320. A model database 330 may include additional NLP and AI models based on the type and amount of data included in the item file, the type and amount of data to be generated, the source of the item file, the type of the client (e.g., retailer, supplier, manufacturer, marketing strategist, etc.), the type of analysis desired, or any combinations thereof. Finally, training databased 340 may contain training data used for the initial training of the models in analytics module 300, for re-training the existing models on new datasets, or for developing additional models.

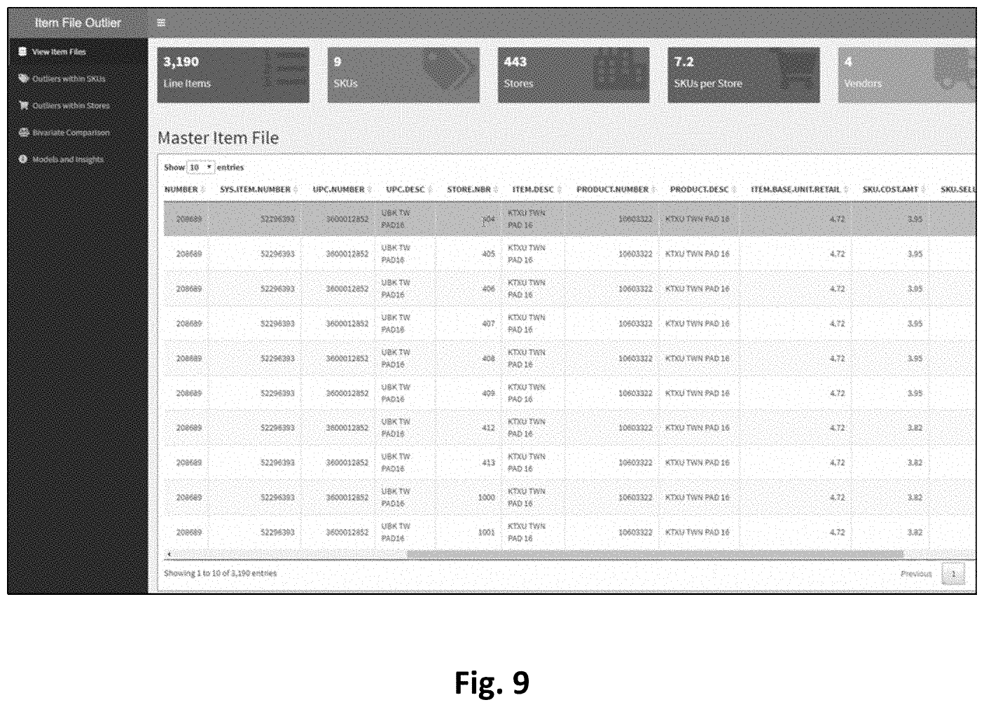

In some embodiments, the data from the item file, once extracted and parsed, are re-organized, tabulated, and presented to user 206 via a graphics user interface (GUI) in software application 202. FIG. 9 shows a partial screenshot from a table containing information extracted from item file 212. The table is viewable by user 206 through software application 202. According to some embodiments, the output from regression analysis model 330 is presented in the form of tables, graphs, or in any other convenient for the user format. By way of example and not limitation, one or more output engines, which may or may not be part of the models in analytics module 300, may be responsible for compiling and presenting the resulting data. In some embodiments, the output engine may be another AI model in model database 330. In some embodiments, the one or more output engines may be part of the analytics module 300 of server 210. Alternatively, the one or more output engines may belong to a remote server communicatively coupled to server 210. The one or more output engines and any additional servers communicatively connected to server 210 are not shown in FIG. 3 for simplicity.

Server 210 is not limited to the example of FIG. 3 and alternative arrangements are within the spirit and the scope of this disclosure. For instance, the databases shown in FIG. 3 can be located in different data centers communicatively coupled to server 210.

### Updating the Model

Because suppliers and retailers ship and receive new inventory daily, the model may perform the analysis described in method 100 as often as possible (e.g., continuously) or as often as required. For example, one or more updated item files may be uploaded as often as required so that product prices in multiple stores are continuously monitored for errors and any discrepancies are timely highlighted and investigated.

### Using the Method and System

Although method 100 is described from the perspective of a retailer owning and managing multiple stores, method 100 can be equally applied to vendors, suppliers, and manufacturers that want to monitor their procurement prices across multiple retailers. For example, a vendor, a supplier, or a manufacturer may want to monitor its procurement prices across different retailers and identify procurement pricing errors that do not align with the agreed upon procurement prices. And because the procurement prices can be different for each retailer, it would be important for the supplier to make sure that the procurement prices in its item files are accurate and constantly updated. For example, the method and system described herein may flag one or more retailers for whom the procurement prices for one or more products do not match the agreed upon prices or are not justified.

Keeping procurement or retail prices checked across different entities, not only protects against capital loss, but also improves the business relationship between the involved parties. In some embodiments, a third party who has access to items files from multiple retailers and suppliers may use the method and system described herein to monitor for procurement pricing errors across the retailers. Perhaps, one particular product from a supplier, has an unusually high or an unusually low procurement price for a subset of the retailers. In such an event, the retailers and the supplier may be notified to investigate whether the questionable procurement price is justified.

According to some embodiments, method 100, as described herein, may be equally applied to services (e.g., in addition to physical products), ecommerce stores (e.g., in addition to physical retail stores), or to any other platform on which products and services are made available for purchase.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described with the figures above. Modules may constitute either software modules (e.g., code embodied on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the claimed invention. This description should be read to include one or at least one and the singular also includes the plural unless it is obvious that it is meant otherwise.

Upon reading this disclosure, those of skill in the art will appreciate still additional alternative structural and functional designs for the system described above. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for detecting price errors and/or discrepancies, the method comprising:
receiving an item file, the item file comprising at least store identifiers, product identifiers corresponding to products sold in stores associated with the store identifiers, and product prices corresponding to the product identifiers;
creating a dataset comprising a first grouping with the store identifiers, a second grouping with the product identifiers, and a third grouping with the product prices;
selecting a first group of the stores;
calculating for each product sold in the first group of the stores a statistical quantity based on the product prices; and
comparing each product's price to the statistical quantity across the first group of the stores to identify stores that have priced their products higher or lower than the statistical quantity.

2. The method of claim 1, further comprising:
applying a predictive model on the dataset to predict a price for each product across the first group of the stores; and
ranking residuals from the regression analysis to identify, within the first group of the stores, products whose prices do not match their predicted prices.

3. The method of claim 2, wherein the predictive model comprises at least one of regression, decision trees, and cross tabulations, and ranking the residuals further comprises identifying one or more stores from the first group of the stores whose one or more product prices do not match their respective predicted prices.

4. The method of claim 1, further comprising:
selecting a second group of the stores different from the first group;
calculating for each product in the second group of the stores another statistical quantity based on the product prices; and
comparing each product's price to the other statistical quantity across the second group of the stores to identify stores that have priced their products higher or lower than the other statistical quantity.

5. The method of claim 4, wherein the stores refer to any channels and mechanisms for providing products and services, and each of the statistical quantity and the other statistical quantity is an average value, a median value, or combinations thereof.

6. The method of claim 1, wherein creating the dataset comprises analyzing the item file with one or more natural language processing programs and one or more artificial intelligence programs.

7. The method of claim 1, wherein the product prices are retail product prices, procurement product prices, or combinations thereof.

8. The method of claim 1, wherein selecting the first group of the stores comprises grouping stores according to one or more criteria.

9. The method of claim 8, wherein the one or more criteria comprises a geographical location of the stores.

10. A method for detecting price errors and/or discrepancies, the method comprising:
receiving an item file, the item file comprising at least store identifiers, product identifiers corresponding to products sold in stores associated with the store identifiers, and product prices corresponding to the product identifiers;
creating a dataset comprising a first grouping with the store identifiers, a second grouping with the product identifiers, and a third grouping with the product prices;
selecting a group of the stores based on one or more criteria;
applying regression analysis on the dataset to predict a price for each product across the group of the stores; and
ranking residuals from the regression analysis to identify, within the group of the stores, products whose prices do not match their predicted prices.

11. The method of claim 10, further comprising:
calculating for each product sold in the group of the stores a statistical quantity based on the product prices; and
comparing each product's price to the statistical quantity across the group of the stores to identify stores that have priced their products higher or lower than the statistical quantity.

12. The method of claim 11, wherein the statistical quantity is an average value, a median value, or combinations thereof.

13. The method of claim 10, wherein the one or more criteria is selected from a group consisting of a geographical location of the stores, size of the stores, sales figures for the stores, and any combinations thereof.

14. The method of claim 10, wherein creating the dataset comprises extracting data from the item file with one or more natural language processing programs and one or more artificial intelligence programs.

15. A computer program product for detecting price errors and/or discrepancies, the computer program product comprising a non-transitory computer-readable medium having computer readable program code stored thereon, the computer readable program code configured to:
receive an item file, the item file comprising at least store identifiers, product identifiers corresponding to products sold in stores associated with the store identifiers, and product prices corresponding to the product identifiers;
create a dataset comprising a first grouping with the store identifiers, a second grouping with the product identifiers, and a third grouping with the product prices;
select a group of the stores based on one or more criteria;
run regression analysis on the dataset to predict a price for each product across the group of the stores; and
rank residuals from the regression analysis to identify, within the group of the stores, products whose prices do not match their predicted prices.

16. The computer program of claim 15, wherein the computer readable program code is further configured to:
calculate for each product sold in the group of stores a statistical quantity based on the product prices; and
compare each product's price to the statistical quantity across the group of the stores to identify stores that have priced their products higher or lower than the statistical quantity.

17. The computer program of claim 16, wherein the statistical quantity is an average value, a median value, or combinations thereof.

18. The computer program of claim 15, wherein the one or more criteria comprises a geographical location for each store.

19. The computer program of claim 15, wherein the computer readable program code uses one or more natural language processing programs and one or more artificial intelligence programs to create the database.

20. The computer program of claim 15, wherein the product prices are retail prices, procurement prices, or combinations thereof.
